(19) United States
(12) Patent Application Publication
(10) Pub. No.: US 2025/0067323 A1
(43) Pub. Date: Feb. 27, 2025

(54) TOOTHED BELT AXIS FOR PROVIDING LINEAR MOVEMENT OF A CARRIAGE

(71) Applicant: Festo SE & Co. KG, Esslingen (DE)

(72) Inventors: Erwin BEZJAK, Ostfildern (DE); Kerstin KUNZ, Esslingen (DE)

(21) Appl. No.: 18/811,115

(22) Filed: Aug. 21, 2024

(30) Foreign Application Priority Data
Aug. 23, 2023 (DE) 102023122568.5

(51) Int. Cl. F16H 7/20; F16H 7/02; F16H 7/18

(52) U.S. Cl. CPC F16H 7/20; F16H 7/023; F16H 2007/185

(57) ABSTRACT

A toothed belt axis for providing a linear movement of a carriage, with a profiled body and a carriage mounted on the profiled body for linear movement along the axis of movement, with a toothed belt pulley and a deflection roller and with a toothed belt, which wraps around the toothed belt pulley and the deflection roller in certain areas and is connected to the carriage. The toothed belt pulley is rotatably received in a first bearing housing. The carriage has a first carriage centering interface and the first bearing housing has a first bearing housing centering interface, which are designed for a translational alignment of the first bearing housing relative to the carriage in a first spatial direction transverse to the axis of movement and for a rotational alignment of the first bearing housing relative to the carriage about the axis of movement.

This application claims priority to German Patent Application No. 102023122568.5 filed Aug. 23, 2023, which is incorporated by reference.

The invention relates to a toothed belt axis for providing a linear movement of a carriage with a profiled body extending along an axis of movement and a carriage mounted on the profiled body so as to move linearly along the axis of movement, with a toothed belt pulley and a deflection roller and with a toothed belt which wraps around the toothed belt pulley and the deflection roller in a respective region and is connected to the carriage, which wraps around the toothed belt pulley and the deflection roller in certain areas and is connected to the carriage, wherein the toothed belt pulley is rotatably received in a first bearing housing which is fixed to a first axial end face of the profiled body by at least one fastening element.

Linear guides are known from the state of the art, in which the carriage is mounted on a base structure so that it can move linearly for particularly precise guidance of the linear movement, in that two first guiding modules bear movably against a first guiding surface and two second guiding modules bear movably against a second guiding surface of the base structure.

If such linear guides are designed as a toothed belt axis, it is necessary for the toothed belt to be guided without misalignment in a first spatial direction transverse to the axis of movement and preferably in a further spatial direction transverse to the axis of movement and orthogonal to the first spatial direction when the toothed belt axis is fully assembled. This prevents the toothed belt from running against, in particular against the profiled body, the toothed belt pulley or the deflection roller, and being damaged. Offset-free guidance also prevents the carriage from tilting in the profiled body.

### SUMMARY OF THE INVENTION

For the purposes of the present application, an axis of movement, which may also be referred to as the z-axis, a transverse axis, which may also be referred to as the y-axis and along which the first spatial direction or the further spatial direction extends, and a height axis, which may also be referred to as the x-axis and along which the first spatial direction or the further spatial direction extends, define a Cartesian coordinate system to which reference is made below, unless expressly stated otherwise.

The present invention is therefore based on the problem of preventing or reducing misalignment in the first spatial direction and/or the further spatial direction.

To solve this problem, it is provided according to the invention in conjunction with the features mentioned at the beginning that the carriage has a first carriage centering interface and the first bearing housing has a first bearing housing centering interface opposite the first carriage centering interface along the axis of movement, which are designed for a translational alignment of the first bearing housing relative to the carriage in a first spatial direction transverse to the axis of movement and for a rotational alignment of the first bearing housing relative to the carriage about the axis of movement.

In this way, it is advantageously possible to align the first bearing housing with respect to the carriage translationally in a first spatial direction transverse to the axis of movement and rotationally about the axis of movement during assembly of the toothed belt axis, for which purpose the first carriage centering interface of the carriage is connected to the first bearing housing centering interface of the first bearing housing during assembly. In this way, the first bearing housing is aligned with respect to the carriage as described above, which in this context can also be referred to as centering. Subsequently, the first bearing housing can be fixed to the first axial end face of the profiled body by means of the fastening element. In this way, the first bearing housing can advantageously be aligned directly relative to the carriage.

In this context, translational alignment in a first spatial direction is understood to mean that displacement of the first bearing housing along this first spatial direction is blocked. The rotational alignment of the first bearing housing relative to the carriage about the axis of movement prevents the first bearing housing from being tilted relative to the carriage by rotation about one or more axes of the coordinate system.

In the present case, the axis of movement is the axis along which the carriage of the toothed belt axis can be moved linearly. This axis does not necessarily coincide with a body axis of a component of the toothed belt axis, for example the profiled body or the first bearing housing.

Preferably, the first spatial direction transverse to the axis of movement is the direction along the transverse axis, as an offset along the height axis can be at least partially compensated for by the toothed belt.

Compared to conventionally designed toothed belt axes, in which the first bearing housing is only aligned with the profiled body and thus only indirectly with the carriage during assembly, a more precise alignment can be achieved with direct alignment of the first bearing housing with the carriage, in which misalignment of the toothed belt is more or less avoided. This results from the fact that the tolerance chain that exists with indirect alignment, in which tolerances between the first bearing housing and the profiled body as well as tolerances between the profiled body and the carriage influence the alignment, is avoided and only the tolerances between the first bearing housing and the carriage influence the alignment.

Advantageous further embodiments of the invention are subject of the dependent claims.

In a further embodiment of the toothed belt axis, the first carriage centering interface has a first centering element, and the first bearing housing centering interface has a second centering element, wherein at least a central axis of the first centering element and a central axis of the second centering element are aligned parallel to the axis of movement, in particular parallel to the axis of movement and coaxial to one another. The first centering element and the second centering element enable a connection of the first carriage centering interface and the first bearing housing centering interface. The first centering element and the second centering element can be designed to correspond to each other, in particular in the manner of a plug-in connection, so that, for example, the first centering element is received at least in part in the second centering element. Alternatively, the first centering element and the second centering element can be designed identically, in which case a centering aid, for example in the form of dowel pins or fitting sleeves, is used during assembly of the toothed belt axis, by means of which the first centering element and the second centering element and thus the first carriage centering interface and the first bearing housing centering interface are indirectly connected to one another. The first bearing housing can then be fixed, and the centering aid removed.

In the present application, the term element is understood to mean both an element which protrudes from a surface on which it is formed, for example in the form of a pin, and an element which extends from a surface as a recess into the body concerned, for example in the form of a hole.

Preferably, the first centering element and/or the second centering element are pin-shaped, in particular cylindrical pin-shaped. A pin-shaped design enables precise production of the first centering element and the second centering element as well as the use of a centering aid designed as a centering sleeve during assembly of the toothed belt axis. However, it is also possible that, for example, only the first centering element is shaped like a cylindrical pin, whereby a cylindrical bore in the first bearing housing corresponding to the first centering element can be used as the second centering element. The use of a centering aid is not necessary in this case.

In a further embodiment, the first centering element and/or the second centering element are designed as a sphere segment, in particular as a sphere cap. If both the first centering element and the second centering element are designed as a sphere segment, a centering sleeve is again used as a centering aid for assembly. If, during assembly or alignment, a first opening of the centering sleeve is brought into contact with the first centering element of the first carriage centering interface or a second opening of the centering sleeve is brought into contact with the second centering element of the first bearing housing centering interface along the axis of movement, an edge of the centering sleeve radially delimiting the first opening slides against a spherical surface of the first centering element or an edge of the centering sleeve radially delimiting the second opening slides against a spherical surface of the second centering element, so that self-centering of the first centering element and the second centering element or the centering sleeve occurs. It is also conceivable to design the first centering element and the second centering element in a corresponding manner, so that, for example, the first centering element is designed as a sphere segment that protrudes from a surface of the carriage and the second centering element is designed as a sphere segment-like recess for receiving the first centering element in sections.

Alternatively, the first centering element is designed as a step-shaped surface element and the second centering element is designed as a surface element corresponding to the first centering element, wherein at least one central plane of the first centering element comprising the central axis of the first centering element and one central plane of the second centering element comprising the central axis of the second centering element being aligned parallel to one another. Due to the step-shaped design and the associated parallel alignment of the central plane of the first centering element and the central plane of the second centering element to each other, a complete rotational alignment of the first bearing housing relative to the carriage is achieved, in which neither rotation about the axis of movement nor about the central axis of the first centering element or about the central axis of the second centering element is possible.

In a preferred embodiment, the first centering element and/or the second centering element are designed as a recess extending along the axis of movement, wherein at least the central axis of the first centering element and the central axis of the second centering element are aligned parallel to the axis of movement, in particular parallel to the axis of movement and coaxial to one another. For example, dowel pins can be used as a centering aid. It is also conceivable that a cross-section of the first centering element designed as a recess and/or a cross-section of the second centering element designed as a recess decreases from an opening of the recess towards a base of the recess along the direction of movement. The respective recess thus tapers from its opening to its base, whereby the larger cross-section in the area of the opening enables easy insertion of the centering aid and the tapering enables self-centering.

Preferably, the first carriage centering interface and/or the first bearing housing centering interface comprise a further centering element which is located at a distance in special direction transverse to the axis of movement from the first centering element and/or the second centering element, which is in particular identical to the first centering element and/or the second centering element and which is designed for translational alignment of the first bearing housing relative to the carriage in a further spatial direction transverse to the axis of movement, the further spatial direction being orthogonal to the first spatial direction. The first bearing housing can be completely aligned by the further centering elements by means of a translational alignment in a further spatial direction and a complete rotational fixation.

Advantageously, the first centering element of the first carriage centering interface has a greater extension along the direction of movement than the further centering element of the first carriage centering interface and/or the second centering element of the first bearing housing centering interface has a greater extension along the direction of movement than the further centering element of the first bearing housing centering interface. For example, during assembly, the first carriage centering interface and the first bearing housing centering interface can initially only be connected via the first centering element and the second centering element, so that at least one rotation about the central axis of the first centering element or about the central axis of the second centering element is possible. If the first bearing housing is fed further onto the carriage along the axis of movement during assembly, the further centering element of the first carriage centering interface can be brought into engagement with the further centering element of the first bearing housing centering interface in order to achieve complete alignment. This procedure makes assembly easier, especially if it is carried out by hand.

One embodiment is considered particularly advantageous, wherein a second bearing housing is fixed to a second axial end face of the profiled body opposite the first axial end face with at least one fastening means, in which the deflection roller is rotatably mounted, wherein the carriage has a second carriage centering interface located at a distance from the first carriage centering interface along the axis of movement and that the second bearing housing has a second bearing housing centering interface opposite the second carriage centering interface along the axis of movement, which is in particular identical to the first bearing housing centering interface and which is designed for a translational alignment of the second bearing housing relative to the carriage in a first spatial direction transverse to the axis of movement and for a rotational alignment of the second bearing housing relative to the carriage about the axis of movement, wherein the deflection roller is rotatable fixed in the second housing bearing. Accordingly, the second bearing housing can also be aligned relative to the carriage as described above.

The above-mentioned problem is also solved by a method for centering a bearing housing of a toothed belt axis. The method comprises the steps: Displacing a carriage mounted on a profiled body extending in a direction of movement along the direction of movement into a first mounting position, positioning the first bearing housing, which can be fixed with at least one fastening means to an axial first end face of the profiled body, in a fastening position, connecting a first carriage centering interface of the carriage to a first bearing housing centering interface of the first bearing housing for translational alignment of the first bearing housing relative to the carriage in a first spatial direction transverse to the axis of movement and for rotational alignment of the first bearing housing relative to the carriage about the axis of movement wherein a central axis of a first centering element of the first carriage centering interface and a central axis of a second centering element of the first bearing housing centering interface are aligned parallel to the axis of movement, in particular parallel to the axis of movement and coaxial to one another.

Instead of a toothed belt, another traction device such as a V-belt or a link chain can also be used.

### BRIEF DESCRIPTION OF DRAWINGS

FIG. 1 a preferred design of the toothed belt axis according to the invention in a perspective view with a carriage mounted for linear movement on a profiled body and a transmission unit comprising a first bearing housing and a second bearing housing,

FIG. 2 a perspective view of the profiled body and the carriage from FIG. 1,

FIG. 3 a front view of the linear guiding device from FIG. 1,

FIG. 4 an exploded view of the carriage, the first bearing housing and a second bearing housing of the transmission unit in a perspective view,

FIG. 5 a sectional view of the toothed belt axis with the profiled body, the carriage, and the transmission unit.

### DETAILED DESCRIPTION OF THE INVENTION

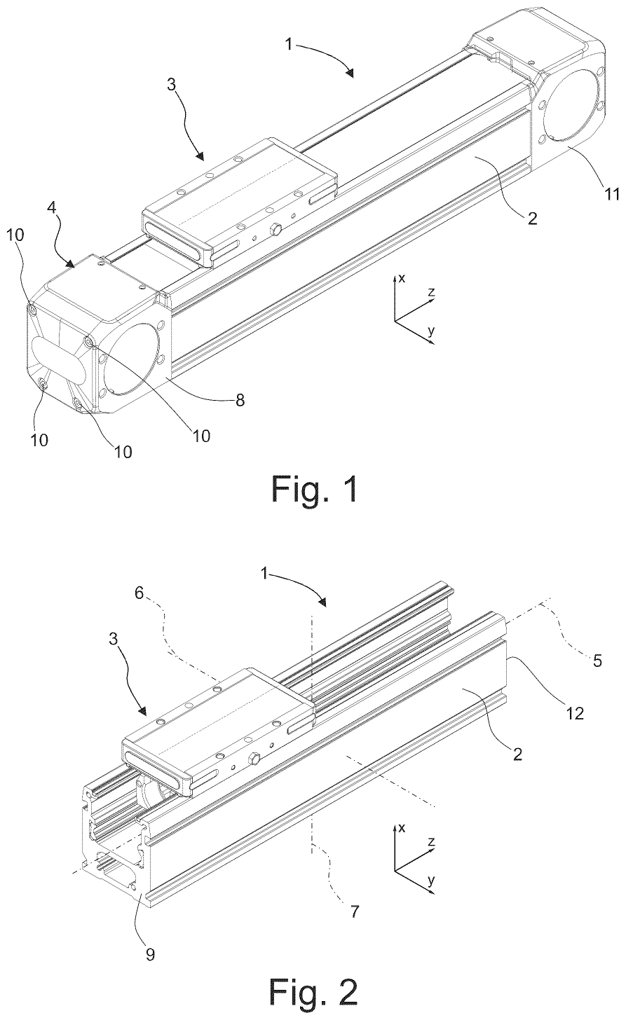

FIG. 1 shows a first version of a toothed belt axis 1 with a profiled body 2, a carriage 3 and a transmission unit 4.

An axis of movement 5, along which the carriage 3 is to be moved linearly, coincides with a longitudinal direction of the toothed belt axis 1. A transverse axis 6 runs perpendicular to the axis of movement 5, with which a transverse direction of the toothed belt axis 1 coincides. Finally, a height axis 7 is oriented orthogonally to the axis of movement 5 and orthogonally to the transverse axis 6, with which a height direction of the toothed belt axis 1 coincides. The axis of movement 5, the transverse axis 6 and the height axis 7 form a Cartesian coordinate system.

In the exemplary embodiment shown, the transmission unit 4 has a first bearing housing 8, which is fixed to a first axial end face 9 of the profiled body 2 by means of a plurality of fastening elements 10, in particular machine screws, and a second bearing housing 11, which is fixed to a second axial end face 12 of the profiled body 2 by means of a plurality of fastening elements (not shown).

As components which are not visible in the figures, the transmission unit 4 has a toothed belt pulley which is accommodated in the first bearing housing 8 such that it can rotate, a deflection roller which is accommodated in the second bearing housing 11 such that it can rotate, and a toothed belt which wraps around the toothed belt pulley and the deflection roller in certain areas and is connected to the carriage 3. To move the carriage 3, the toothed belt pulley can be connected to a motor (not shown), in particular an electric motor, mounted on the first bearing housing 8. As an example, the toothed belt is designed as an endless belt, but can also have an alternative design.

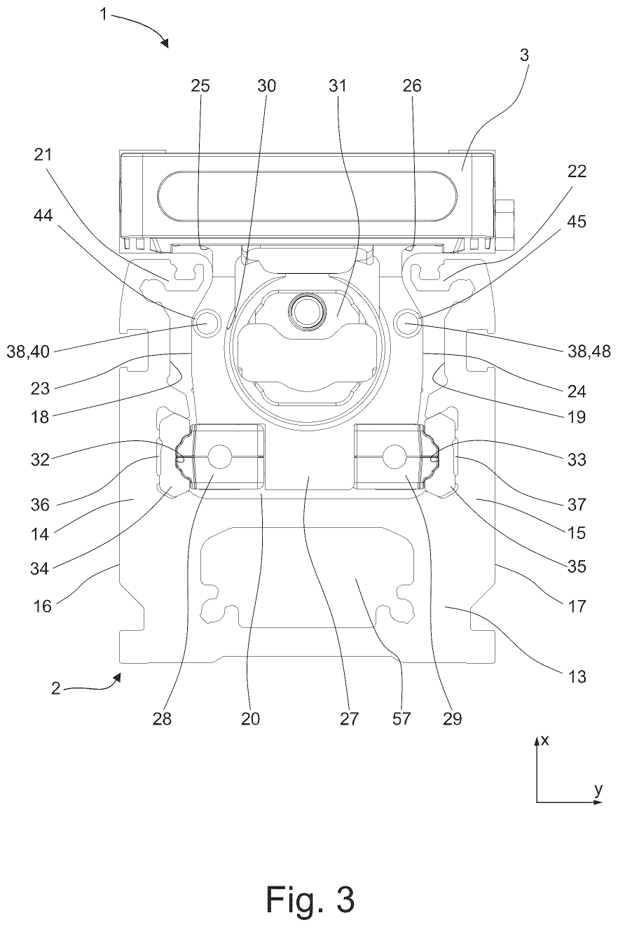

As can be seen in FIG. 2 and in particular in FIG. 3, the profiled body 2 has a base body 13 with a longitudinal direction extending along the direction of movement 5, from which a first leg 14 and a second leg 15, which are spaced apart from one another along the transverse axis 6, project along the height axis 7. The base body 13 shown has a profile recess 57 extending through the entire base body 13. A substantially U-shaped cross-section is formed by the base body 13, the first leg 14 and the second leg 15, which is constant over the entire extension of the profiled body 2 along the axis of movement 5, as can be seen in particular in the front view in FIG. 3. Furthermore, the profiled body 2 has a first outer side 16, a second outer side 17, a first inner side 18 and a second inner side 19 opposite the first inner side 18. Consequently, the base body 13 together with the first inner side 18 and the second inner side 19 form a channel-shaped receiving space 20, which extends over the entire extent of the profiled body 2 in the direction of movement 5. In the assembled state, the carriage 3 and the toothed belt are accommodated partly in the receiving space 20, so that the carriage 3 is linearly displaceable along the axis of movement 5 in the receiving space 20. Along the height axis 7, the receiving space 20 is delimited by two overhangs 21, 22, the two overhangs 21, 22 being formed at an end of the first leg 14 opposite the base body 13 and at an end of the second leg 15 opposite the base body 13. In order to prevent displacement of the carriage 3 in the height direction, the carriage 3 is designed in such a way that it has a height recess 25, 26 on a first carriage outer side 23 and on a second carriage outer side 24, which in the assembled state correspond in their position along the height axis 7 with the overhangs 21, 22 of the profiled body 2.

The carriage 3 shown has a guiding unit 27 with a first guiding module 28 located on the carriage 3 and with a second guiding module 29 located on the carriage 3 opposite the first guiding module 28 at a distance along the transverse axis 6. A toothed belt mounting point 31 located in a central recess 30 of the carriage 3 is provided for connecting the carriage 3 to the toothed belt.

In the embodiment shown, the first guiding module 28 and the second guiding module 29 are designed as recirculating ball bearing guiding modules, each of which has a plurality of rolling bearing elements arranged in a row in two channels lying one above the other along the height axis 7 (not shown). In the present case, the rolling bearing elements are designed as balls, but may have other suitable geometries in other embodiments. It is also conceivable that the first guiding module 28 and the second guiding module 29 are designed as different types of rolling bearing guiding modules or as sliding guiding modules.

For precise guidance of the linear movement of the carriage 3 along the axis of movement 5, a first guide surface 32 is provided on the first inner side 9 and a second guide surface 33 is provided on the second inner side 10, so that the carriage 3 can be mounted on the profiled body 2 so that it can move linearly along the axis of movement 5 by the rolling bearing elements of the first guiding module 28 bearing against the first guide surface 32 and the rolling bearing elements of the second guiding module 29 bearing against the second guide surface 33. During the linear movement, the rolling bearing elements of the first guiding module 28 run along the first guiding surface 32 and the rolling bearing elements of the second guiding module 29 run along the second guiding surface 33, whereby the contact between the rolling bearing elements of the first guiding module 28 and the first guiding surface 32 and between the rolling bearing elements of the second guiding module 29 and the second guiding surface 33 provides support in the transverse direction of the carriage 3 with respect to the profiled body 2, so that an exact linear movement of the carriage 3 is made possible.

As can be seen in FIG. 3, the first guiding surface 32 is formed on a first guide rail 34 and the second guiding surface 33 is formed on a second guide rail 35, which in the embodiment shown are designed as separate components, the first guide rail 34 and the second guide rail 35 being designed in the present case as profiles extending in the longitudinal direction with a constant cross-section.

The first guide rail 34 is received in a first receiving groove 36 in the first inner side 9 and the second guide rail 35 is received in a second receiving groove 37 in the second inner side 10, wherein the first receiving groove 36 and the second receiving groove 37 are each formed in a region adjacent to the base body 13. In the embodiment shown in FIG. 3, the dimensions of the first guide rail 34 and the second guide rail 35 as well as the first receiving groove 36 and the second receiving groove 37 are selected such that there is a force-locked connection in each case. Alternatively, a force-locked and material-locked connection or a material-locked connection are also conceivable.

For a translational alignment of the first bearing housing 11 relative to the carriage 3 in a first spatial direction transverse to the axis of movement 5, exemplarily along the transverse axis 6, and for a rotational alignment of the first bearing housing 11 relative to the carriage 3 about the axis of movement 5, as can be seen in FIGS. 3 to 5 the carriage 3 has a first carriage centering interface 38 prepared for the translational and rotational alignment described above and the first bearing housing 11 has a first bearing housing centering interface 39 opposite the first carriage centering interface 38 along the axis of movement 5 and prepared for the translational and rotational alignment described above.

In the following, the translational alignment of the first bearing housing 11 relative to the carriage 3 in a spatial direction transverse to the axis of movement 5 and a rotational alignment of the first bearing housing 11 relative to the carriage 3 about an axis of movement 5 is referred to as alignment, unless otherwise specified. This applies analogously to the respective alignment of the second bearing housing 12.

In the embodiment shown, the first carriage centering interface 38 has a first centering element 40 and the first bearing housing centering interface 39 has a second centering element 41, which in the present case are designed as recesses extending along the axis of movement 5. A first central axis 42 of the first centering element 40 and a central axis 43 of the second centering element 41 are aligned parallel to the axis of movement 5 and coaxial to one another in the centered or aligned state shown.

A chamfer 44, 45 is formed at an opening of the first centering element 40 and at an opening of the second centering element 41. For the most precise alignment possible, the central axis 42 of the first centering element 40 runs essentially at right angles to a first end face 46 of the carriage 3 and the central axis 43 of the second centering element 41 runs essentially at right angles to a profile-side end face 47 of the first bearing housing 8. As an example, the first carriage centering interface 38 has a further centering element 48 spaced apart from the first centering element 40 along the transverse axis 6 and the first bearing housing centering interface 39 has a further centering element 49 spaced apart from the second centering element 41 along the transverse axis 6, which in the present case is identically designed in each case to the first centering element 40 and second centering element 40. In this way, the first bearing housing 11 is aligned in translation relative to the carriage 3 in a further spatial direction transverse to the axis of movement 5, with the further spatial direction running orthogonally to the first spatial direction and, in the present case, along the height axis 7.

In an analogous manner, the carriage 3 has a second carriage centering interface 50 spaced apart from the first carriage centering interface 38 along the axis of movement and the second bearing housing 11 has a second bearing housing centering interface 51 opposite the second carriage centering interface 50 along the axis of movement 5 and formed identically to the first bearing housing centering interface 38, bearing housing centering interface 51, which are designed for a translational alignment of the second bearing housing 12 relative to the carriage 3 in a first spatial direction transverse to the axis of movement 5 and for a rotational alignment of the second bearing housing 12 relative to the carriage 3 about the axis of movement 5.

As an example, the second carriage centering interface 50 and the second bearing housing centering interface 51 are designed identically to the first carriage centering interface 38 and identically to the first bearing housing centering interface 39, respectively. Accordingly, the second carriage centering interface 50 has a first centering element 40 and the second bearing housing centering interface 51 has a second centering element 41, which in the present case are designed as recesses extending along the axis of movement 5. A first central axis 42 of the first centering element 40 and a central axis 43 of the second centering element 41 are aligned parallel to the axis of movement 5 and coaxial to one another in the centered or aligned state shown. A chamfer 44, 45 is formed at an opening of the first centering element 40 and at the opening of the second centering element 41. For the most precise alignment possible, the central axis 42 of the first centering element 40 runs essentially at right angles to a second end face 52 of the carriage 3 and the central axis 43 of the second centering element 41 runs essentially at right angles to a profile-side end face 53 of the second bearing housing 11.

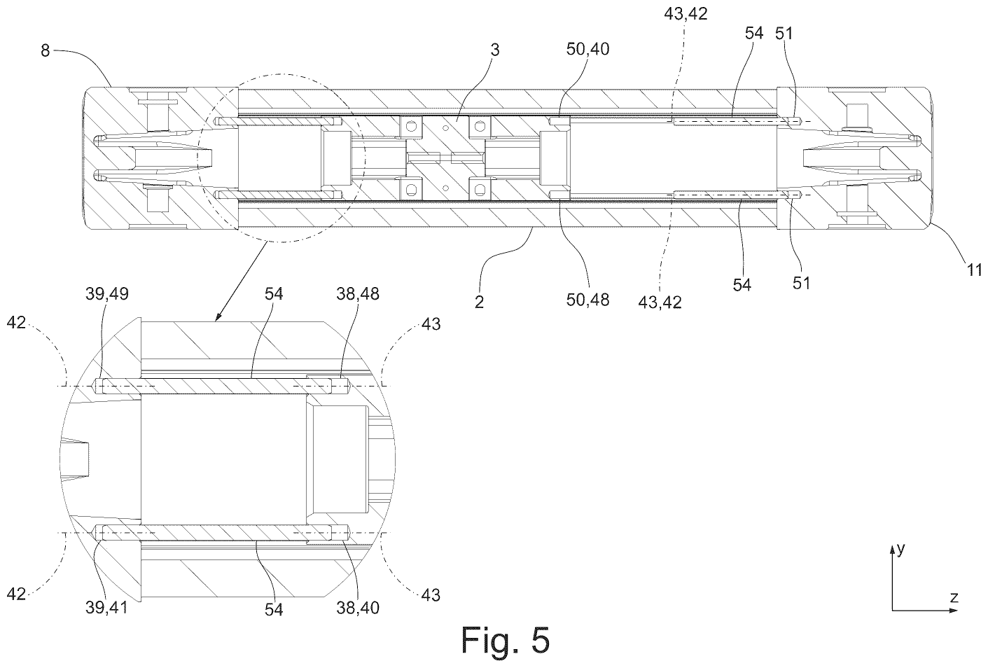

In order to align the first bearing housing 11 with respect to the carriage 3, the carriage 3 mounted on the profiled body 2 is displaced along the direction of movement 5 into a first mounting position (FIG. 5) and the first bearing housing 11 is positioned at the first axial end face 9 in a first mounting position. The first carriage centering interface 38 of the carriage 3 is then connected to the first bearing housing centering interface 39 of the first bearing housing 11, with the central axis 42 of the first centering element 40 of the first carriage centering interface 38 and the central axis 43 of the second centering element 41 of the first bearing housing centering interface 39 being aligned parallel to the axis of movement 5 and coaxial to one another. Once alignment has been completed, the first bearing housing 11 can be fixed to the first axial end face 9 of the profiled body 2 by means of the fastening elements 10.

To align the second bearing housing 12 with respect to the carriage 3, the carriage 3 is pushed along the axis of movement 5 into a second mounting position and the second bearing housing 12 is positioned at the second axial end face 12 in a second mounting position. Now the second carriage centering interface 50 of the carriage 3 is connected to the second bearing housing centering interface 51 of the second bearing housing 12, whereby the central axis 42 of the first centering element 40 of the second carriage centering interface 50 and the central axis 43 of the second centering element 41 of the second bearing housing centering interface 51 are aligned parallel to the axis of movement 5 and coaxial to each other. Once alignment has been completed, the second bearing housing 11 can be fixed to the second axial end face 12 of the profiled body by means of the fastening elements 10.

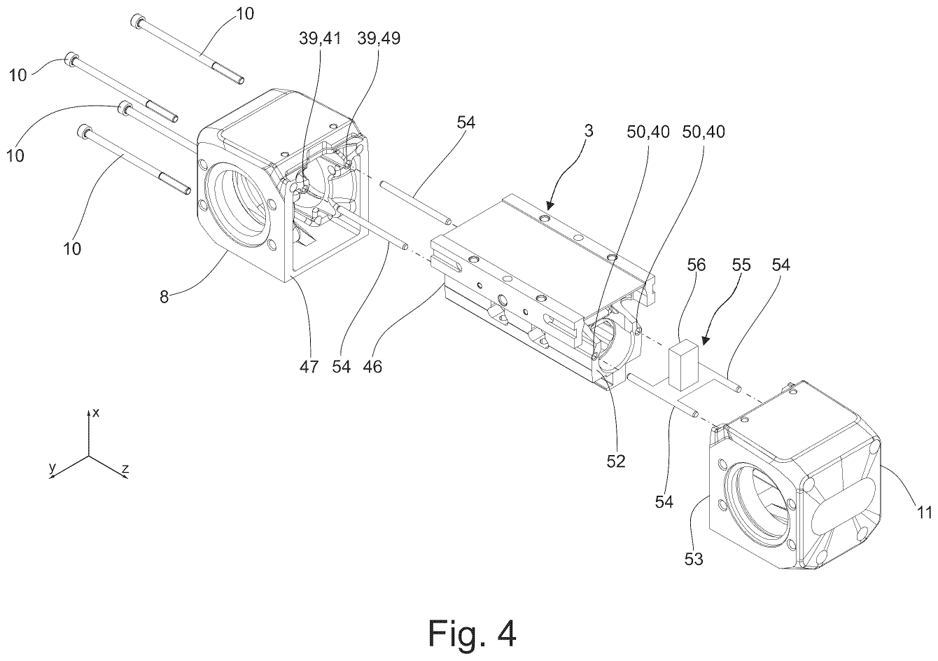

As shown in particular in FIGS. 4 and 5, in the embodiment shown, centering means 54 are used to connect the first carriage centering interface 38 of the carriage 3 to the first bearing housing centering interface 39 of the first bearing housing 11, which are partly accommodated in the first centering element 42 and in the second centering element 43 for the alignment. By way of example, these can be designed as individual dowel pins. Alternatively, a centering gauge 55 (FIG. 4) can also be used, on which two centering means 54 are located at a distance from one another in a spatial direction and which has a retaining section 56, which for example can be held or clamped in a corresponding device.

In alternative embodiments of the toothed belt axis 1 not shown, the first centering element 40 and/or the second centering element 41 can be pin-shaped, in particular cylindrical pin-shaped, or designed as a sphere segment, in particular as a sphere cap. In each case, it is possible for the first centering element 40 and the second centering element 41 to be identical or to correspond to each other. If the first centering element 40 and the second centering element 41 are identical, a centering means is used for alignment, which is designed to correspond to the first centering element 40 and the second centering element 41, so that either the first centering element 40 and the second centering element 41 are accommodated in sections in the centering means or the centering means is accommodated in corresponding sections in the first centering element 40 and in the second centering element 41.

If the first centering element 40 and the second centering element 41 are designed to correspond to each other, the use of the centering means can be omitted. An example of a corresponding design would be a design of the first centering element 40 as a cylindrical pin, which is received in sections in the second centering element 41 designed as a cylindrical bore.

In a further alternative embodiment, the first centering element 40 can be designed as a step-shaped surface element and the second centering element 41 as a surface element corresponding to the first centering element, wherein at least one central plane of the first centering element 40 comprising the central axis 42 of the first centering element 40 and one central plane of the second centering element 41 comprising the central axis 43 of the second centering element 41 are aligned parallel to one another.

1. Toothed belt axis for providing a linear movement of a carriage with a profiled body extending along an axis of movement and a carriage mounted on the profiled body for linear movement along the axis of movement, with a toothed belt pulley and a deflection roller and with a toothed belt, which wraps around the toothed belt pulley and the deflection roller in certain areas and is connected to the carriage, wherein the toothed belt pulley is rotatably received in a first bearing housing, which is fixed to a first axial end face of the profiled body by at least one fastening means, wherein the carriage has a first carriage centering interface and the first bearing housing has a first bearing housing centering interface opposite the first carriage centering interface along the axis of movement, which are designed for a translational alignment of the first bearing housing relative to the carriage in a first spatial direction transverse to the axis of movement and for a rotational alignment of the first bearing housing relative to the carriage about the axis of movement.

2. The toothed belt axis according to claim 1, wherein the first carriage centering interface has a first centering element, and the first bearing housing centering interface has a second centering element, wherein at least a central axis of the first centering element and a central axis of the second centering element are aligned parallel to the axis of movement, in particular parallel to the axis of movement and coaxially to one another.

3. The toothed belt axis according to claim 2, wherein the first centering element and/or the second centering element are pin-shaped, in particular cylindrical pin-shaped.

4. The toothed belt axis according to claim 2, wherein the first centering element and/or the second centering element are designed as a sphere segment, in particular as a sphere cap.

5. The toothed belt axis according to claim 2, wherein the first centering element is designed as a step-shaped surface element and the second centering element is designed as a step-shaped surface element corresponding to the first centering element, wherein at least one central plane of the first centering element comprising the center line of the first centering element and one central plane of the second centering element comprising the center line of the second centering element being aligned parallel to one another.

6. The toothed belt axis according to claim 2, wherein the first centering element and/or the second centering element are designed as a recess extending along the axis of movement, wherein at least the central axis of the first centering element and the central axis of the second centering element are aligned parallel to the axis of movement, in particular parallel to the axis of movement and coaxial to one another.

7. The toothed belt axis according to claim 2, wherein the first carriage centering interface and/or the first bearing housing centering interface comprise a further centering element, which is located at a distance in a spatial direction transverse to the axis of movement from the first centering element and/or the second centering element, which is in particular identical to the first centering element and/or the second centering element and which is designed for translational alignment of the first bearing housing relative to the carriage in a further spatial direction transverse to the axis of movement, wherein the further spatial direction extends orthogonally to the first spatial direction.

8. The toothed belt axis according to claim 2, wherein the first centering element of the first carriage centering interface has a greater extent along the direction of movement than the further centering element of the first carriage centering interface and/or the second centering element of the first bearing housing centering interface has a greater extent along the direction of movement than the further centering element of the first bearing housing centering interface.

9. The toothed belt axis according to claim 1, wherein a second bearing housing is fixed to a second axial end face of the profiled body opposite the first axial end face with at least one fastening means, in which the deflection roller is rotatably mounted, wherein the carriage has a second carriage centering interface located at a distance from the first carriage centering interface along the axis of movement and that the second bearing housing has a second bearing housing centering interface opposite the second carriage centering interface along the axis of movement, which is in particular identical to the first bearing housing centering interface, and which is designed for a translational alignment of the second bearing housing relative to the carriage in a first spatial direction transverse to the axis of movement and for a rotational alignment of the second bearing housing relative to the carriage about the axis of movement.

10. A method for centering a first bearing housing of a toothed belt axis, comprising the steps of:
displacing a carriage mounted on a profiled body extending in a direction of movement along the direction of movement into a first mounting position,
positioning the first bearing housing, which can be fixed with at least one fastening means to an axial first end face of the profiled body, in a fastening position,
connecting a first carriage centering interface of the carriage to a first bearing housing centering interface of the first bearing housing for translational alignment of the first bearing housing relative to the carriage in a first spatial direction transverse to the axis of movement and for rotational alignment of the first bearing housing relative to the carriage about the axis of movement, wherein a central axis of a first centering element of the first carriage centering interface and a central axis of a second centering element of the first bearing housing centering interface are aligned parallel to the axis of movement.
